(19) United States
(12) Patent Application Publication
(10) Pub. No.: US 2025/0174953 A1
(43) Pub. Date: May 29, 2025

(54) COAXIAL CABLE CONNECTOR ASSEMBLY METHOD, COAXIAL CABLE CONNECTOR, AND CRIMPING TOOL

(71) Applicant: TE Connectivity Solutions GmbH, Schaffhausen (CH)

(72) Inventors: Olivier DE CLOET, Bensheim (DE); Matthew Steven HOUSER, Middletown, PA (US)

(21) Appl. No.: 18/959,352

(22) Filed: Nov. 25, 2024

(30) Foreign Application Priority Data
Nov. 29, 2023 (EP) 23213173.0

(51) Int. Cl. H01R 43/048; H01R 4/18; H01R 11/28; H01R 24/40; H01R 43/042

(52) U.S. Cl. CPC H01R 43/0488; H01R 4/185; H01R 11/28; H01R 24/40; H01R 43/0421

(57) ABSTRACT

The subject matter herein includes a method for assembling a coaxial cable connector, a crimping tool for assembling a coaxial cable connector, and a coaxial cable connector. The subject matter includes crimping an inner ferrule onto an exposed braid of the coaxial cable, folding back an exposed braid of the coaxial cable over the inner ferrule, and crimping an outer contact onto the folded-back exposed braid, wherein the outer contact has distinct constrictions of reduced diameter in predetermined functional zones to reduce elongation of the outer contact and compression of the cable. This subject matter reduces the need for multiple terminal components, streamlines the assembly process, and ensures reliable mechanical and electrical connections for diverse applications.

### CROSS REFERENCE TO RELATED APPLICATIONS

This application claims the benefit of EP application No. 23/213,173.0, filed 29 Nov. 2023, the subject matter of which is herein incorporated by reference in its entirety.

### BACKGROUND OF THE INVENTION

The subject matter herein pertains to the field of coaxial cable connector assembly, with a particular focus on improving the assembly process for small-diameter coaxial cables. It relates to innovative methods, connectors, and associated crimping tools that are configured to enhance the performance, reliability, and reusability of these connectors in various applications.

Coaxial cables are renowned for their ability to transmit high-frequency signals with minimal loss and reduced electromagnetic interference, making them integral in a variety of industries, including telecommunications, automotive, aerospace, and consumer electronics. The effectiveness and functionality of coaxial cables in these applications hinge crucially on the quality, integrity, and, notably, the adaptability of their connectors, especially when considering the need for compatibility across various cable sizes and the challenges in maintaining signal integrity during connector assembly.

In traditional coaxial cable connector assembly, the process typically involves crimping a ferrule onto the cable's shield braid, followed by attaching an outer contact, to establish a secure and electrically conductive connection. However, this crimping process, though effective for its intended purpose, has historically been limited in its scope and adaptability. For each different cable size, a unique crimp barrel design has been necessary, leading to an extensive variety of connector parts and specialized crimping tools, each suited to a specific cable diameter. This level of specialization, while necessary for ensuring proper connections, results in considerable manufacturing expenses, compounded by the complexities of inventory management and logistics due to the diversity of parts required.

Moreover, when components originally designed for larger cable diameters are employed with smaller cables, traditional crimping methods frequently result in material redundancy and excessive elongation of the crimp zone during the crimping process, due to the surplus material that was intended for larger diameters. This elongation can adversely affect the positional stability of the center contact in the connector assembly. Consequently, such displacement may detrimentally influence the electrical performance of the coaxial cable, particularly manifesting as impedance mismatches and compromises in signal integrity. These issues are critical in applications where maintaining consistent electrical characteristics is paramount for the functionality of the coaxial cable system.

One of the principal limitations of the current state of the art in coaxial cable connector assembly is the lack of reusability and adaptability in crimp barrel designs. The conventional approach, which tailors crimp barrels specifically to certain cable diameters, restricts their use to a limited range of cable sizes. This lack of versatility not only contributes to a greater environmental impact due to the need for manufacturing an array of single-size-specific parts, but also leads to increased costs associated with the production and inventory management of cable connectors.

Consequently, the industry has consistently faced the challenge of developing a crimping methodology that not only accommodates a broad spectrum of cable sizes, including smaller diameter cables, but also does so without compromising the essential integrity of electrical connections. This balanced approach is crucial for ensuring consistent and reliable signal transmission in coaxial cables.

### BRIEF DESCRIPTION OF THE INVENTION

Various embodiments disclosed herein have an object of providing an efficient method for assembling coaxial cable connectors, enabling component reuse across cable sizes, optimizing crimping with versatile crimping tools, and ensuring high-performance coaxial cable connectors.

The above object is achieved by the provision of a method for assembling a coaxial cable connector as set out in the claims, a crimping tool for this assembly as set out in the claims, and a coaxial cable connector itself as set out in the claims. Advantageous further developments of the subject matter are set forth in the dependent claims.

In an embodiment, a method for assembling a coaxial cable connector includes the steps of:
a. providing a coaxial cable;
b. crimping an inner ferrule onto an exposed braid of the coaxial cable;
c. folding back an exposed braid of the coaxial cable over the inner ferrule; and
d. crimping an outer contact onto the folded-back exposed braid, wherein the outer contact has distinct constrictions of reduced diameter in predetermined functional zones to reduce elongation of the outer contact and compression of the cable.

The subject matter herein introduces a methodical approach to assembling a coaxial cable connector that incorporates features of an outer contact with specialized constrictions. This feature collectively enhances the functionality, usability, and adaptability of the connector to different cable sizes while ensuring the integrity of the electrical connections and signal transmission.

The process begins with the provision of a suitable coaxial cable, which is a crucial initial step in the coaxial cable connector assembly process, especially given the emphasis on accommodating various cable sizes. This involves selecting a suitable cable type and ensuring that it meets the specific requirements of the intended application, such as diameter, signal frequency, and environmental resistance.

The subsequent crimping of an inner ferrule onto an exposed braid of the cable is a critical operation. This step requires precise alignment and attachment of the ferrule to the braid, which is the basis of the cable's shielding effectiveness.

This crimp ensures a secure mechanical and electrical connection between the cable and the ferrule. Proper crimping is essential to maintain the signal integrity of the cable, as it preserves the continuity of the shield and minimizes electromagnetic interference.

An exposed braid of the cable is then folded back over the inner ferrule. This action strengthens the joint and prepares the assembly for the next critical step.

The crimping of the outer contact onto the folded-back exposed braid is an improvement compared to traditional methods. The outer contact is configured with distinct constrictions in predetermined functional zones.

This feature significantly reduces the risk of cable elongation and over-compression during crimping. The constrictions in the outer contact are configured to ensure that crimp pressure is applied accurately and effectively.

This precise application of pressure maintains the integrity of the mechanical and electrical connections that are critical to the performance of the coaxial cable.

Reduced diameter constrictions in specific zones mitigate the issue of material redundancy and elongation that occurs when reusing crimp barrels intended for larger cable diameters with conventional crimping practices. These constrictions are strategically positioned and shaped to minimize unnecessary material deformation during the crimping process.

By focusing on these functional zones, the method ensures a secure crimp without applying excessive force that could deform the cable or compromise its electrical performance. This precise crimping approach is critical to the integrity of the connection.

This feature is particularly beneficial in maintaining the characteristic impedance of the coaxial cable, which is essential for high frequency signal transmission. The controlled crimping process helps to maintain the structural and electrical properties of the cable, ensuring optimum signal quality.

Overall, this process represents a refined approach to coaxial cable connector assembly, ensuring greater reliability, consistency, and adaptability across a range of cable sizes. This meets the industry's need for versatile and efficient manufacturing processes, addressing challenges in connector assembly and providing a solution that is both practical and innovative.

In another embodiment, a crimping tool for assembling a coaxial cable connector includes at least one of:
a. an interchangeable die set corresponding to a specified cable diameter, along with an adjustable mechanism for setting crimp height, configured for use with a universal inner ferrule provided with overlapping crimp flanks to allow adaptation to a range of cable diameters; and
b. a crimp profile featuring constrictions positioned to apply pressure selectively to predetermined functional zones of an outer contact, wherein the constrictions are configured to prevent excessive elongation of the outer contact during crimping.

The crimping tool features an adjustable mechanism for setting crimp height, which allows for precise customization to the specific dimensions of the coaxial cable and thereby surmounts a significant restriction associated with traditional crimping tools. Although particular cable diameters may require the use of different crimping tools, the components—especially the inner ferrule—maintain standardization for use across a range of cable diameters.

The die set is specifically configured with an adjustable crimp height feature to enable precise adaptation of the overlap between the ferrule's overlapping flanks for optimal fit, particularly in the case of smaller-diameter cables. This configuration element provides a versatile crimping process that can be finely tuned to suit the precise requirements of various cable diameters.

Different crimping tools, each with dedicated die sets, are essential to efficiently accommodate coaxial cables of varying sizes, ensuring that the reusable inner ferrule can be utilized effectively across the spectrum of cable dimensions. This flexibility is especially beneficial in various applications where cable diameters can vary, allowing for a wider range of applications.

By reusing identical connector components across different cable diameters, harness manufacturers can significantly reduce material stock, even though a distinct crimping tool is required for each cable size. This not only minimizes manufacturing costs, but also streamlines the assembly process, resulting in greater efficiency and reduced complexity in manufacturing setups.

The crimping tool has a special crimp profile with constrictions that selectively apply pressure to predetermined functional zones of the outer contact. These constrictions are meticulously configured to prevent excessive elongation of the outer contact during the crimping process.

This aspect of the outer contact configuration directly addresses and mitigates the issue of material redundancy and associated elongation problems that are common with traditional crimping geometries. By effectively controlling elongation, the tool plays a critical role in maintaining the positional integrity of the center contact, thereby ensuring the electrical performance of the coaxial cable, particularly in terms of maintaining consistent impedance and optimal signal integrity.

The subject matter herein represents a significant advancement in the field of coaxial cable connector assembly. It introduces a versatile and efficient solution that not only ensures high quality connections, but also promotes a more sustainable approach by enabling the use of reusable connector components for multiple cable sizes.

This adaptability, combined with the ability to maintain the integrity of electrical connections, makes the subject matter herein particularly valuable in industries such as telecommunications, automotive, and aerospace, where the extensive use of coaxial cable demands both reliability and versatility.

In another embodiment, a coaxial cable connector is provided including at least one of:
a. an inner ferrule crimped onto an exposed braid of a coaxial cable, the ferrule including adjustable overlapping flanks to accommodate coaxial cables of varying diameters; and
b. an outer contact crimped onto an exposed braid of a coaxial cable folded back over an inner ferrule which in turn is crimped onto an exposed braid of the coaxial cable, the outer contact having distinct constrictions of reduced diameter in predetermined functional zones, the constrictions being configured to minimize elongation of the outer contact during crimping and thereby maintain positional integrity of a center contact within the connector.

The described coaxial cable connector incorporates innovative features that substantially enhance its adaptability and performance. Certain elements of subject matter herein, which are effective both in combination and as standalone improvements, include the following:

The adjustable inner ferrule is equipped with overlapping flanks, enabling it to adapt to coaxial cables of various diameters. This adaptability is essential for creating a versatile connector compatible with a range of cable sizes. By reducing the necessity for multiple size-specific ferrules, this feature streamlines the manufacturing process and lowers inventory requirements.

The outer contact, which is secured to the inner ferrule and the folded-back exposed braid of the cable, has distinct constrictions in specific functional zones. These constrictions, characterized by their reduced diameter, are strategically positioned to limit the elongation of the outer contact during the crimping process. This elongation control is critical to maintaining the positional integrity of the center contact within the connector. In turn, maintaining this positional integrity is critical to ensuring optimal electrical performance of the connector, as any misalignment of the center contact can result in impedance mismatch and compromise signal integrity.

The advantages of the subject matter herein are substantial and varied. The adaptability of the inner ferrule, which can accommodate coaxial cables of various diameters, greatly expands the utility of the connector in a variety of applications, including telecommunications and automotive systems. The outer contact is precisely configured to maintain the electrical and mechanical properties of the connector throughout the assembly process, thereby ensuring reliable and consistent performance. Furthermore, this configuration significantly contributes to reducing material waste and enhancing the overall efficiency of the connector assembly process.

In summary, the present invention represents a notable advancement in coaxial cable connector technology that effectively addresses the industry's prevalent challenges of versatility, reliability, and performance.

### BRIEF DESCRIPTION OF THE DRAWINGS

Additional features and benefits of the present invention, along with details of its preferred embodiments, are elucidated in the subsequent detailed description, which references the accompanying drawings. These drawings illustrate:

FIG. 1: cross-sectional views of coaxial cable connector assemblies for a large-diameter coaxial cable (RTK031) and a small-diameter coaxial cable (RG174), also including perspective views of the individual components of these assemblies, each depicted in an uncrimped condition;

FIGS. 2a, 2b, 2c and 2d: a step-by-step process (steps 1 to 14) of a method for assembling a coaxial cable connector, clearly demonstrating the methodical sequence involved in the assembly;

FIGS. 3a and 3b: two distinct external views of an inner ferrule, shown crimped onto an exposed braid of a small-diameter coaxial cable, prior to application of an outer contact;

FIG. 4: an external view of the inner ferrule of FIGS. 3a and 3b, shown crimped onto an exposed braid of a large-diameter coaxial cable, prior to application of an outer contact;

FIGS. 5a, 5b and 5c: three distinct external views (side, top, and bottom) of a coaxial cable connector, in accordance with an exemplary embodiment, attached to a small-diameter coaxial cable, highlighting the unique constricted configuration of the outer contact;

FIG. 6: a side external view of a coaxial cable connector, attached to a large-diameter coaxial cable, featuring the outer contact of FIGS. 5a, 5b, and 5c in a non-constricted configuration; and

FIGS. 7a and 7b: cross-sectional views (top and side) of a coaxial cable connector, in accordance with an exemplary embodiment, attached to a small-diameter cable, emphasizing the distinctive constrictions in diameter located at the functional zones of the connector.

### DETAILED DESCRIPTION OF THE INVENTION

In the ensuing detailed description section, exemplary embodiments of the coaxial cable connector 1 and the assembly method are explored, as depicted in the accompanying drawings. This section comprehensively outlines the innovative approach of the subject matter herein, detailing the adaptable and efficient features that distinguish it from prior art. The illustrated embodiments serve to demonstrate the practical application of these novel features and the substantial advantages they confer.

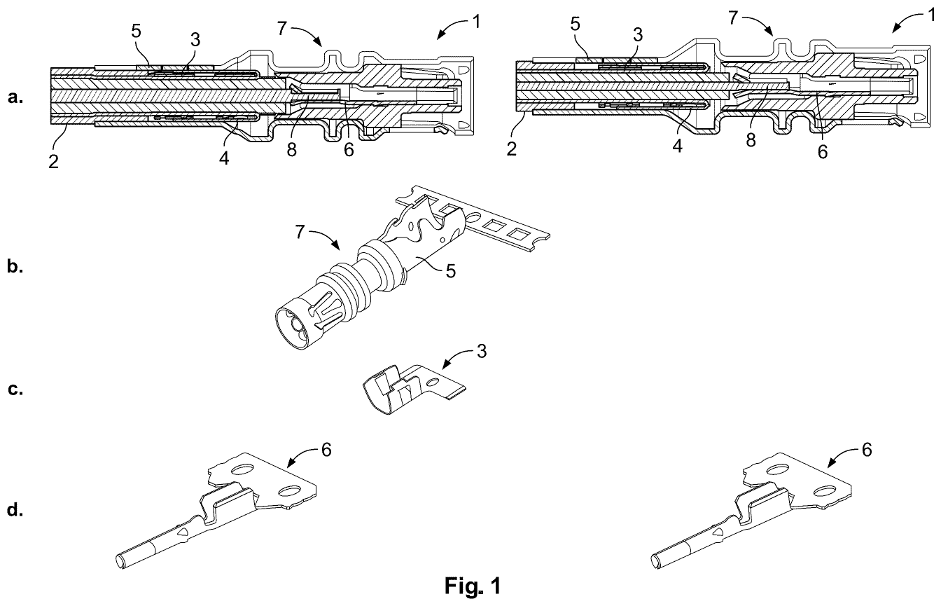

FIG. 1 showcases two configurations of a coaxial cable connector assembly in the upper portion marked with the label “a.”. On the left, the assembly is connected to a large-diameter coaxial cable 2 of the RTK031 type, and on the right, it is paired with a small-diameter coaxial cable 2 of the RG174 type. These representations illustrate the connector's 1 adaptability to different cable sizes. The cross-sectional depictions reveal how the connector's 1 internal components are adeptly suited to cables 2 of varying diameters, reflecting the innovative configuration central to the connector's 1 assembly methodology.

Each connector configuration incorporates a center contact 6, visualized in the lower portion marked with the label “d.”. These center contacts 6 are configured to form an electrical junction with the inner conductor 8 of the coaxial cable 2. The center contacts 6 are differentiated by their diameters to match the internal specifications of the RTK031 and RG174 cables 2, thereby facilitating adaptability to these two distinct cable types.

In the central portion of FIG. 1, labeled “b.”, a subassembly 7 is depicted in its original, uncrimped condition. This subassembly 7 incorporates an outer contact 5, which is configured to be mechanically and electrically secured to the braid 4 of the cable 2. The standardization of subassembly 7 for use with varying cable diameters demonstrates the subject matter herein, substantially reducing the necessity for a broad spectrum of parts specifically designed for different cable sizes. This consistent design approach for subassembly 7, applicable to a variety of connector types, signifies a leap forward in the standardization of connector components, indicating a shift away from traditional manufacturing methods.

Additionally, in the central portion of FIG. 1, labeled “c.”, an inner ferrule 3 is shown in its initial, uncrimped state. Positioned between the outer contact 5 and the folded-back braid 4 on the outside, and the non-folded braid 4 and the cable's 2 dielectric layer on the inside, the inner ferrule 3 plays a crucial role in ensuring a stable and consistent assembly process. The inner ferrule 3 is configured for compatibility with both large-diameter and small-diameter cables 2 to streamline the assembly process for connectors 1. This approach further enhances manufacturing efficiency by further reducing the variety of components required.

As a result, the coaxial cable connector 1 significantly reduces production and logistical costs by limiting the variances to the center contact 6, the only component configured for specific cable diameters. This design ingenuity underpins the capability to streamline and economize the production of coaxial cable connectors 1, underscoring the practical and cost-effective benefits of this technological advancement.

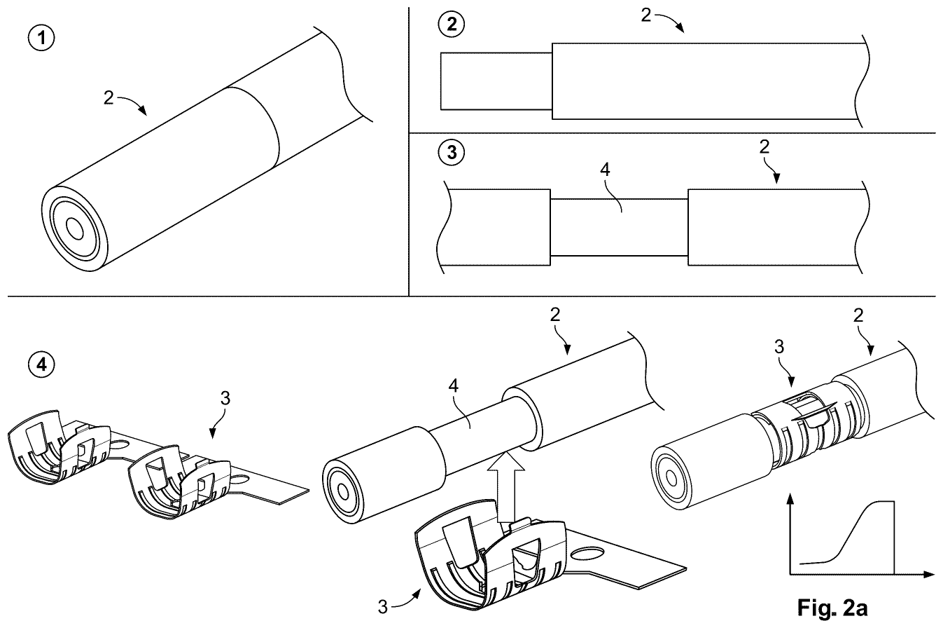

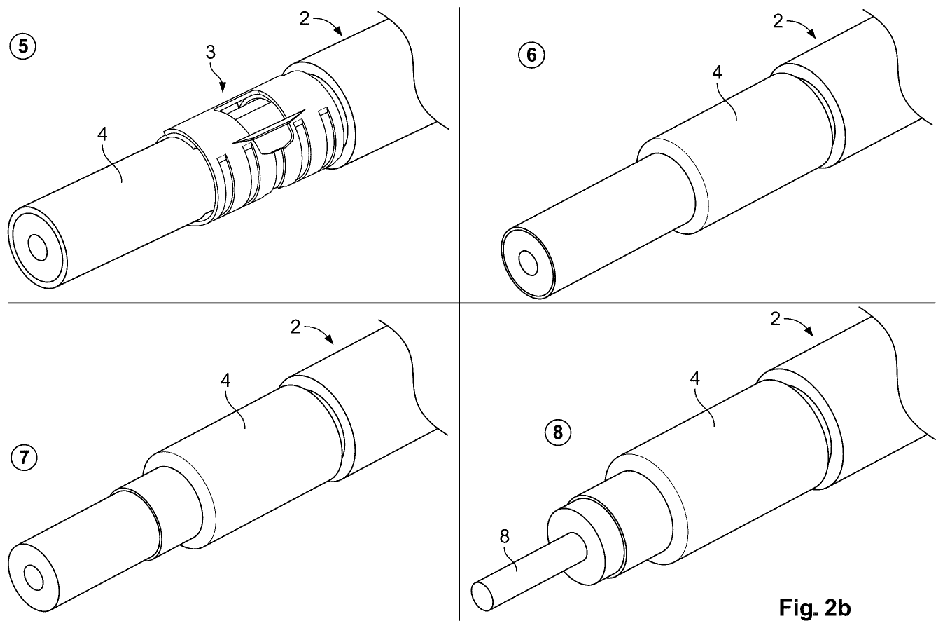

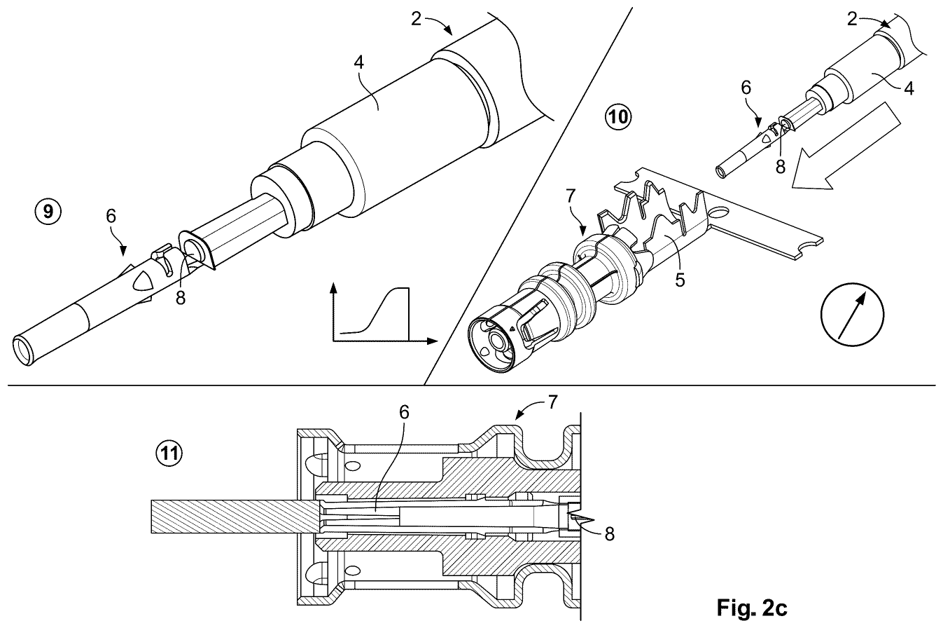

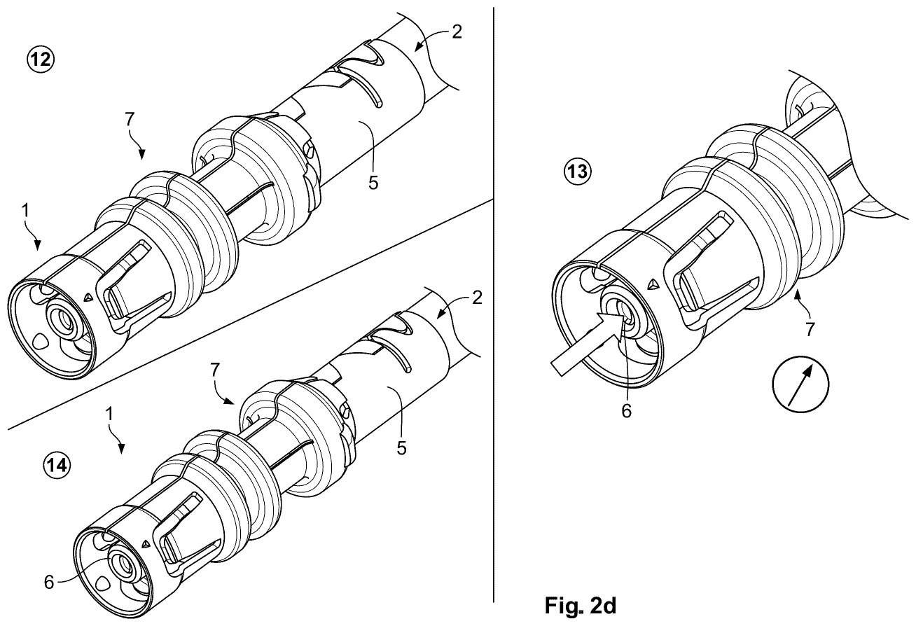

FIGS. 2a to 2d methodically outline the sequence of steps, numbered 1 through 14, required to attach a coaxial cable connector 1 to the end of a coaxial cable 2. These steps are as follows:

In step 1 (FIG. 2a), the coaxial cable 2 is cut to a specified length with precision, an essential first step that establishes a consistent starting point for the connector assembly process.

In step 2 (FIG. 2a), a precise primary cutting action is effected to remove a portion of the outer jacket, including the underlying braid 4 and foil, from one end of the cable 2. This action exposes the essential layers needed to attach a connector to that end.

Step 3 (FIG. 2a) involves a secondary cutting (stripping) action on the same end of the coaxial cable 2, meticulously configured to remove a segment of the outer jacket and reveal a specific longitudinal section of the braid 4, while leaving the insulation intact at the very end of the cable 2 to prevent the braid 4 from fraying or unraveling. This operation is essential for the subsequent attachment of the inner ferrule 3 of the coaxial cable connector 1, which will be attached to this end of the cable 2.

In step 4 of FIG. 2a, the assembly process of the coaxial cable connector 1 onto the coaxial cable 2 begins by carefully crimping the inner ferrule 3—marked with label “c.” in FIG. 1—onto the exposed braid 4 of the coaxial cable 2. After crimping, a quality inspection is performed to verify the secure attachment and structural integrity of the ferrule 3.

Step 5 (FIG. 2b) of the cable processing procedure removes any remaining semi-strip on the cable end section between the crimped inner ferrule 3 and the distal end of the cable 2. This step ensures that the braid 4 within this longitudinal end section of the cable is fully exposed.

After removing the semi-strip in step 5, the exposed braid 4 at the end of the cable 2 is carefully folded back 180 degrees over the crimped inner ferrule 3 as illustrated in step 6 of FIG. 2b. This action is critical to increasing mechanical stability and optimizing electrical grounding of the assembly.

After folding back the exposed braid 4 in step 6, step 7 (FIG. 2b) involves the precise trimming of the inner foil from the cable end, at the location where the braid 4 has been folded back. This procedure ensures that the additional layer of shielding is properly shaped to complement the assembly.

In step 8 (FIG. 2b), the dielectric insulator is carefully trimmed back from the end of the cable 2 to expose the inner conductor 8. Special care is taken to ensure that no remnants of the foil are left behind that could compromise signal integrity.

Step 9 (FIG. 2c) is to crimp the center contact 6—marked with label “d.” in the lower portion of FIG. 1—onto the now exposed inner conductor 8 of the coaxial cable 2. This critical step establishes the electrical path necessary for signal transmission.

In step 10 of FIG. 2c, the end of the coaxial cable 2, now with the newly crimped center contact 6, is inserted into the subassembly 7 that comprises the outer contact 5 and is marked with label “b.” in the central portion of FIG. 1. This process positions the components for final assembly.

Step 11 (FIG. 2c) involves verifying the precise longitudinal position of the center contact 6 by tactile inspection. This ensures that the contact 6 is correctly aligned within the connector 1 for optimal electrical connectivity.

The outer contact 5 of the subassembly 7 is subsequently crimped onto the folded-back exposed braid 4, which overlays the inner ferrule 3. This step 12 in FIG. 2d fortifies the mechanical connection and forms a consistent electrical shield encircling the cable 2.

In step 13 of FIG. 2d, an electrical test is performed to confirm the proper assembly of the connector 1, with particular attention paid to the length and precise positioning of the center contact 6 to guarantee reliable electrical connectivity.

Following the electrical test, step 14 (FIG. 2d) involves labeling or marking the cable 2 to provide identification and facilitate traceability. This is an essential practice for maintaining quality control and simplifying future maintenance or repair activities.

A final step 15 (not illustrated) prepares the fully assembled coaxial cable connector 1 for installation within its designated housing, which may include telecommunications equipment, automotive systems (in particular, automotive data connectivity applications), space instruments, or other advanced applications.

Employing the assembly process outlined in FIGS. 2a to 2d facilitates the creation of a reliable and durable coaxial cable connector assembly, specifically configured to maintain signal integrity in high-frequency applications, reflecting the innovation's emphasis on precision and versatility in connector manufacturing. This assembly process upholds rigorous precision standards and minimizes the reliance on a wide range of specialized tools and components. This enhanced efficiency is particularly advantageous in high-volume manufacturing settings, where consistency, reliability, and cost-effectiveness are pivotal factors.

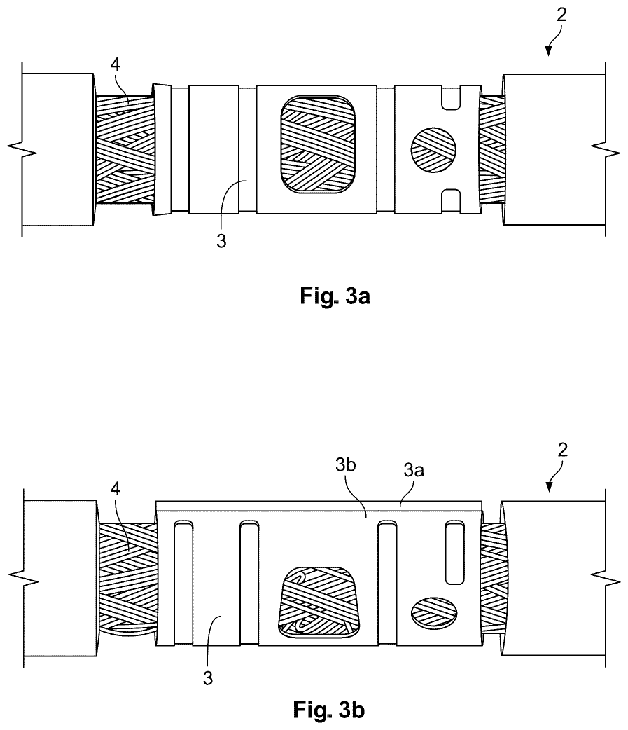

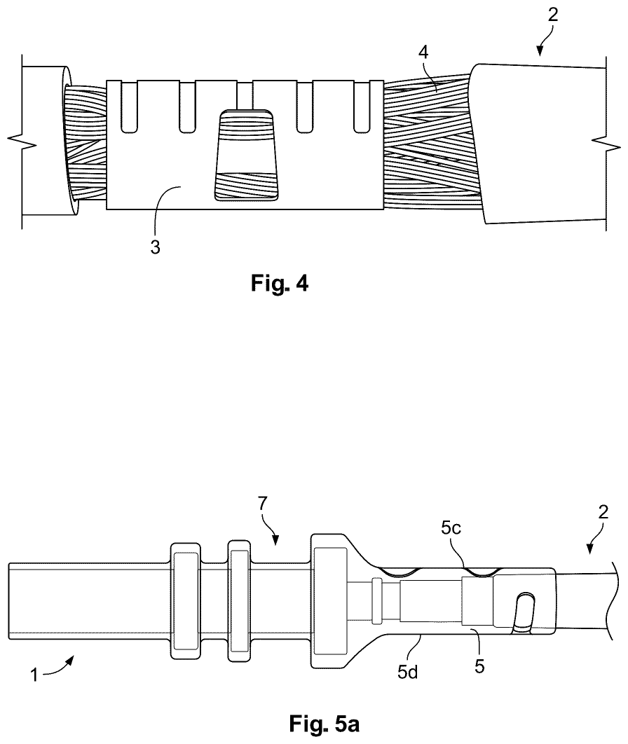

FIGS. 3a and 3b illustrate the crimping of an inner ferrule 3 onto the exposed braid 4 of a small-diameter RG174 type coaxial cable 2, using a crimping tool set to a width of 2.25 mm, achieving a crimp height (CH) of 2.50. This particular ferrule 3 is identical to the one employed for the larger-diameter RTK031 type coaxial cable 2 (see FIG. 4), showcasing the capability to adapt to various cable sizes while reducing the number of distinct components required.

The ferrule 3 features uniquely designed overlapping flanks 3a, 3b—clearly visible in the side view of FIG. 3b—allowing for an adjustable fit that can be tailored to the smaller diameter of the RG174 cable 2. This adaptability is achieved by increasing the overlap of the flanks 3a, 3b to conform to the cable's 2 internal diameter, ensuring a secure and consistent crimp. The implementation of such overlapping flanks 3a, 3b facilitates component reuse and enabling a streamlined manufacturing process across different cable sizes. Thus, FIGS. 3a and 3b emphasize an approach to maintaining the integrity of connections while optimizing logistical efficiency through component standardization.

In preparation for the application of the outer contact 5, the inner ferrule 3 is uniformly crimped along the length of the braid 4 that has been exposed by the cable preparation steps, specifically the second cut as outlined in step 3 of FIG. 2a. This consistent crimping technique, as depicted in FIGS. 3a and 3b, is integral to the inventive approach of component standardization, which facilitates a streamlined assembly process and mitigates the complexity of manufacturing and logistics. This methodological crimping innovation ensures compatibility of the same ferrule components across different cable diameters, which not only simplifies the manufacturing workflow but also contributes to overall cost efficiency.

In the connector assembly method depicted, the inner ferrule 3 is initially crimped onto the exposed braid 4 of the coaxial cable 2. Following the process outlined in steps 5 and 6 in FIG. 2b, the semi-strip is removed from the longitudinal section of cable 2 that extends from the crimped inner ferrule 3 towards the cable's 2 distal end. The exposed braid 4 is then meticulously folded back 180 degrees over the ferrule 3. This action not only enhances the mechanical stability of the assembly but also ensures consistent electrical grounding. The precise application of the outer contact 5, as demonstrated in subsequent steps 10 to 13 of FIGS. 2c and 2d, facilitates maintaining the electrical integrity and performance of the connector 1 in accordance with an exemplary embodiment.

FIG. 4, complementing the approach illustrated in FIGS. 3a and 3b, showcases a side view of the inner ferrule 3, crimped onto the braid 4 of an RTK031 type coaxial cable 2, using a crimping tool set to a width of 2.75 mm and achieving a crimp height (CH) of 2.90. This illustration again shows the intermediate stage detailed in step 4 of FIG. 2a, where the braid 4 is exposed by stripping the cable's 2 outer jacket. The ferrule 3 is then crimped onto this exposed braid 4, accommodating the larger diameter of the RTK031 cable 2 by adjusting the overlap of the crimp flanks 3a, 3b accordingly.

The illustration affirms the principle of adaptable component configuration, allowing the same ferrule 3 to be used for cables 2 of different diameters, thereby streamlining manufacturing processes and reducing inventory complexities. This approach exemplifies the contribution to efficient manufacturing by limiting the variety of components needed, which aligns with the overarching aim of reducing production and logistical costs.

The crimping tool incorporates an adjustable mechanism specifically for setting the crimp height, a pivotal feature in this assembly process. This adjustability allows for precise matching of the crimp height to the unique dimensions of each coaxial cable 2, enabling the versatile use of a universal ferrule 3 across a diverse range of cable sizes. This innovative approach facilitates standardization in the assembly process and enhances the economic and efficient production of coaxial cable connectors 1, by streamlining the use of standardized components, particularly the ferrule 3, for various cable diameters.

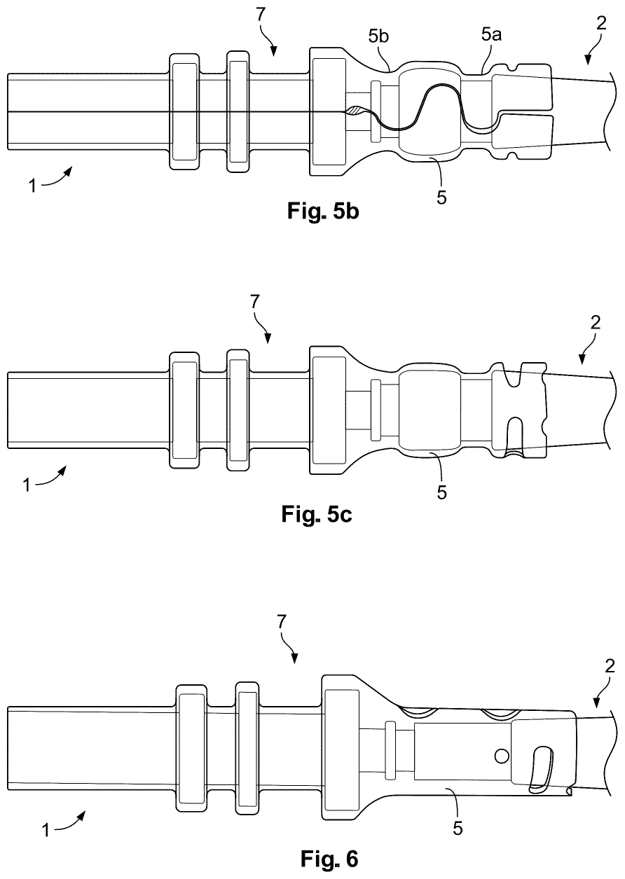

FIGS. 5a, 5b, and 5c present different external views—side, top, and bottom—of a coaxial cable connector 1, assembled with a small-diameter RG174 coaxial cable 2. These illustrations capture the connector 1 in its final state of assembly, emphasizing the constricted regions on the outer contact 5. These constrictions of reduced diameter are strategically implemented to enhance both the mechanical and electrical functionality of the connector 1. The mechanical functional zone 5a, indicated in the top view of FIG. 5b, provides structural stability and a secure grip, while the electrical functional zone 5b, also evident in the top view of FIG. 5b, ensures the maintenance of consistent impedance and electrical continuity, which are vital for the coaxial cable's 2 signal integrity. The refined crimping approach, focusing diameter-reducing pressure only on these critical zones, allows for minimal distortion and preserves the RF signal quality of the coaxial cable 2.

FIGS. 5a, 5b, and 5c illustrate the coaxial cable connector 1 in its final assembled form, where the center contact 6, connected to the inner conductor 8 of the coaxial cable 2, has been incorporated into the subassembly 7. The outer contact 5 of the subassembly 7 is then precisely crimped onto the exposed braid 4, which has been folded back over the inner ferrule 3.

This crimping is performed using a specialized crimping tool with a crimp profile configured to exert diameter-reducing pressure selectively only on predetermined functional zones 5a, 5b of the outer contact 5: mechanical functional zone 5a and electrical functional zone 5b. This crimping tool configuration ensures that the crimping process avoids excessive elongation of the outer contact 5, thereby maintaining the structural and electrical integrity of the coaxial cable connector assembly, in particular of the center contact 6. Proper positioning of the center contact 6 is crucial, as any longitudinal shift could result in an impedance mismatch and compromise the electrical performance of the connector 1.

The configuration of the outer contact 5 incorporates targeted constrictions of reduced diameter that serve specific purposes within the connector's 1 assembly. The mechanical functional zone 5a is engineered to enhance the structural stability and ensure a secure grip within the crimped contact, contributing to the connector's 1 robustness. Simultaneously, the electrical functional zone 5b is optimized to maintain consistent impedance and ensure uninterrupted electrical continuity, which is vital for the connector's 1 signal transmission performance.

This strategic crimping methodology permits the adaptation of an outer contact 5, typically associated with larger-diameter coaxial cables 2, for use with smaller-diameter coaxial cables 2. By concentrating the crimping action on these crucial functional zones 5a, 5b, the connector 1 avoids exerting unnecessary pressure on the intervening material. This careful preservation of the material's original state between zones contributes to the cable's 2 overall flexibility and the preservation of signal integrity, showcasing a nuanced approach to enhancing coaxial cable connector functionality.

The outer contact 5, as observed in FIG. 5a, features flat top and bottom surfaces 5c and 5d, enabling precise measurement of the crimp height. This configuration detail ensures that crimping is consistently applied across the connector 1, critical for maintaining the mechanical and electrical integrity of the connection. The crimping process itself is finely tuned to minimize capacitive distortion, to maintain the quality of RF signal transmission through the coaxial cable 2. Such attention to detail underscores a commitment to ensuring the effectiveness of the coaxial cable connector 1 in various applications where signal fidelity is paramount.

The coaxial cable connector 1, as depicted in FIGS. 5a, 5b, and 5c, embodies the inventive concept of configuring components that are both reusable and versatile, capable of interfacing with various cable diameters. This approach streamlines the manufacturing process by reducing the need for multiple, size-specific components, and enhances the functional adaptability of the connector 1, facilitating its application across a range of coaxial cable types and sizes. The strategic placement of constrictions in the outer contact 5, visible in these FIGS. 5a, 5b, and 5c, is central to this adaptability, allowing for efficient assembly while maintaining the essential mechanical and electrical properties required for reliable high-frequency signal transmission.

FIG. 6 illustrates the subassembly 7 connected to a large-diameter (RTK031 type) coaxial cable 2. The subject matter herein facilitates the use of an identical subassembly 7 for both large-diameter (RTK031 type) and small-diameter (RG174 type) cables 2, exemplifying the versatility of the connector configuration. Unlike the specialized constrictions employed in the small-diameter cable 2 depicted in FIGS. 5a, 5b, and 5c, the outer contact 5 seen here in FIG. 6 adheres to a standard crimp geometry. This approach involves an even crimping over the entire length of the outer contact 5, without the targeted diameter constrictions present in the assemblies for small-diameter cables 2. The standardization of the subassembly 7 across different cable diameters underscores innovative aspects of the subject matter herein, which allows for component reuse and efficient manufacturing without compromising the connector's 1 functionality.

FIG. 6 displays a conventional crimping method applied to a large-diameter coaxial cable 2, type RTK031. This traditional crimping technique involves applying uniform pressure across the entire length of the outer contact 5, ensuring it securely grips the braid 4, which is folded back over the ferrule 3. Historically, such a uniform crimping approach was standard practice for coaxial cables of all diameters, predicated on the belief that a consistent design throughout the contact was essential to maintain mechanical and electrical integrity.

The subject matter herein introduces a novel approach, shifting from the traditional uniform crimping method to a more advanced technique that utilizes localized crimping in predetermined functional zones 5a, 5b. This innovation demonstrates that specialized crimp designs can effectively maintain mechanical and electrical reliability for small-diameter cables 2, akin to the results achieved with larger diameters. By employing specialized crimping tools that execute a targeted circular crimp process, the subject matter herein ensures a consistent and secure contact without the risk of over-expanding (over-elongating) the outer contact 5. This precise crimping method is crucial for preserving the stability of the center contact 6 and the overall electrical integrity of the coaxial cable connector 1, thus marrying the benefits of versatility with technical efficiency.

The figures presented underscore the innovative aspects of the subject matter herein, which harmonizes economic efficiency with advanced technical capabilities. FIGS. 5a, 5b, and 5c, in concert with FIG. 6, illustrate that the same subassembly 7 can be effectively utilized for varying cable diameters without compromising the connector's 1 performance. The technique of employing distinct constrictions in the outer contact 5 for small-diameter cables 2, as depicted in FIGS. 5a, 5b, and 5c, retains the mechanical and electrical integrity of the connector 1. This is in contrast to the standard uniform crimping applied to larger-diameter cables 2 as seen in FIG. 6, demonstrating versatility and successful challenge of the subject matter herein compared to traditional crimping methods. The distinct constrictions of reduced diameter allow for the use of a consistent subassembly component across a range of cable sizes, streamlining manufacturing processes while ensuring reliable connector functionality.

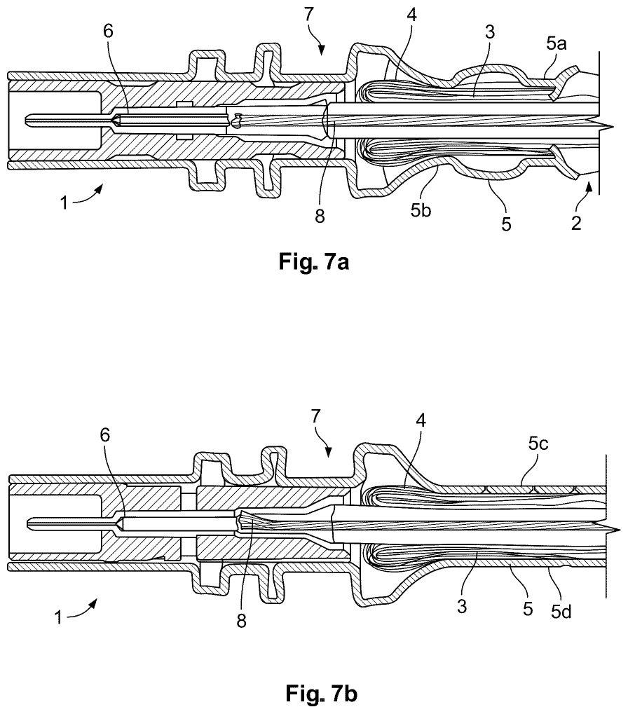

FIGS. 7a and 7b depict cross-sectional longitudinal views of a coaxial cable connector assembly, showcasing both top (FIG. 7a) and side (FIG. 7b) perspectives. These figures detail the assembly involving a small-diameter RG174 type coaxial cable 2 and the connector 1. The assembly is presented in its final state, with the center contact 6 secured within the subassembly 7, and the outer contact 5 of the subassembly 7 crimped onto the backward-folded braid 4 of the coaxial cable 2.

The top sectional view in FIG. 7a accentuates the connector's 1 innovative crimp geometry, where distinct constrictions of reduced diameter are localized in the mechanical and electrical functional zones 5a and 5b, respectively. These zones are precisely shaped by a specialized crimping tool, which narrows the diameter selectively at points where the outer contact 5 interfaces with the backward-folded braid 4 of the coaxial cable 2. The mechanical functional zone 5a is designed to bolster the structural stability and grip of the connection, whereas the electrical functional zone 5b is crucial for ensuring the coaxial cable's 2 operational electrical continuity and impedance matching.

FIG. 7b provides a side sectional view that showcases the outer contact's 5 flat top and bottom surfaces 5c and 5d. These planar references are crucial for accurately gauging the crimp height, thereby facilitating a consistent crimping process across the assembly. This design detail is a testament to the connector's 1 engineered precision, contributing to its reliable and uniform functionality.

The inner ferrule 3, which is fitted onto the cable's braid 4 before the subassembly step, features adjustable overlapping flanks 3a, 3b configured to accommodate coaxial cables 2 of various diameters, demonstrating the connector's 1 capacity for versatile application. This feature allows for a seamless accommodation of cables 2 measuring between 1.5 mm and 3.5 mm in diameter, exemplifying the capacity to cater to diverse specifications while streamlining the manufacturing process by reducing the need for multiple, size-specific ferrules 3.

FIGS. 7a and 7b exhibit the novel configuration of the coaxial cable connector 1, featuring specialized crimping zones (mechanical and electrical functional zones 5a and 5b) that secure both the mechanical robustness and electrical continuity of the connection. In addition, the versatility of the inner ferrule 3, capable of adjusting to various cable diameters, along with the outer contact's 5 flat surfaces 5c, 5d, which facilitate accurate crimp height measurement, represent further significant enhancements in the technology of coaxial cable connector assemblies.

The subject matter herein marks a significant advancement in coaxial cable connector assembly, characterized by an innovative crimping methodology and component configuration. This approach enables the use of uniform subassemblies 7 across a range of cable diameters, thereby significantly simplifying manufacturing processes and reducing costs. The introduction of distinct constrictions of reduced diameter in functional zones 5a, 5b ensures mechanical stability and electrical reliability, without compromising signal integrity. This adaptable methodology not only streamlines production but also enhances the versatility of coaxial cable connectors 1, meeting the evolving demands of the telecommunications, automotive, and aerospace industries.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A method for assembling a coaxial cable connector, the method comprising the steps of:
a. providing a coaxial cable;
b. crimping an inner ferrule onto an exposed braid of the coaxial cable;
c. folding back an exposed braid of the coaxial cable over the inner ferrule; and
d. crimping an outer contact onto the folded-back exposed braid, wherein the outer contact has distinct constrictions of reduced diameter in predetermined functional zones to reduce elongation of the outer contact and compression of the cable.

2. The method according claim 1, wherein the functional zones comprise at least one mechanical functional zone configured primarily to impart structural stability and grip within the crimped outer contact, and at least one electrical functional zone configured primarily to ensure consistent impedance and electrical continuity.

3. The method according claim 1, wherein the inner ferrule has overlapping crimp flanks configured to accommodate different cable sizes, and the overlapping crimp flanks of the inner ferrule are crimped using crimping tools having varying crimp widths, each selected based on the specific cable size, the crimping tools also having an adjustable crimp height setting to ensure an increased overlap of the overlapping flanks required for smaller-diameter cables.

4. The method according claim 1, further comprising the step of:
e. measuring the crimp height of the outer contact using its top and bottom flat surfaces as reference points to ensure consistent crimping throughout the method of assembling the coaxial cable connector.

5. The method according claim 1, wherein the coaxial cable is of an RG174 type.

6. The method according claim 1, wherein the crimping of the outer contact is performed to minimize capacitive distortion, thereby preserving RF signal integrity of the coaxial cable.

7. A coaxial cable connector comprising:
a coaxial cable having an exposed braid;
an inner ferrule crimped onto the exposed braid of the coaxial cable, wherein the exposed braid is folded back over the inner ferrule; and
an outer contact crimped onto the folded-back exposed braid, wherein the outer contact has distinct constrictions of reduced diameter in predetermined functional zones to reduce elongation of the outer contact and compression of the cable.

8. The coaxial cable connector according to claim 7, wherein the functional zones include at least one mechanical functional zone configured primarily to impart structural stability and grip within the crimped outer contact and at least one electrical functional zone configured primarily to ensure consistent impedance and electrical continuity.

9. The coaxial cable connector according to claim 7, wherein the inner ferrule has overlapping crimp flanks configured to accommodate different cable sizes.

10. The coaxial cable connector according to claim 7, wherein at least one of the inner ferrule and the outer contact is configured to be reusable and adaptable for accommodating coaxial cables of varying diameters.

11. The coaxial cable connector according to claim 7, wherein the constrictions are configured to maintain positional integrity of a center contact within the connector.

12. A crimping tool for assembling a coaxial cable connector, comprising:
a. an interchangeable die set corresponding to a specified cable diameter, along with an adjustable mechanism for setting crimp height, configured for use with a universal inner ferrule provided with overlapping crimp flanks to allow adaptation to a range of cable diameters; and
b. a crimp profile featuring constrictions positioned to apply pressure selectively to predetermined functional zones of an outer contact, wherein the constrictions are configured to prevent excessive elongation of the outer contact during crimping.

13. The crimping tool according to claim 11, wherein the crimp height is adjustable to optimize overlap and secure crimping of the overlapping crimp flanks of the inner ferrule for the range of cable diameters, thereby ensuring consistent mechanical and electrical performance across the range of cable diameters.

14. The crimping tool according to claim 11, wherein the constrictions are distinctly defined for mechanical and electrical functional zones of the outer contact.

15. The crimping tool according to claim 11, wherein the crimp profile is specifically tailored to prevent over-compression of the coaxial cable, thereby preserving RF signal integrity.

16. The crimping tool according to claim 11, further comprising a measurement gauge for determining crimp height on the outer contact, the measurement gauge being configured to use top and bottom flat surface references of the outer contact for accurate measurement.
